(19) United States
(12) Patent Application Publication
(10) Pub. No.: US 2003/0190844 A1
(43) Pub. Date: Oct. 9, 2003

(54) Portable multibranch protective extension cord

(76) Inventor: Arthur Foux, Stone Mountain, GA (US)

Correspondence Address: Oltman, Flynn & Kubler, 415 Galleria Professional Building, 915 Middle River Drive, Ft. Lauderdale, FL, 33304, US

(21) Appl. No.: 10/113,503

(22) Filed: Apr. 3, 2002

(51) Int. Cl. H01R 25/00

(52) U.S. Cl. 439/638

(57) ABSTRACT

A portable multibranch extension cord includes in one embodiment a female plug having a shroud, a plurality of surge protection components contained in the shroud, and a plurality of branches from the female plug terminated in a plug, with one of the plugs being configured for connection to a main power source. In another embodiment, the shroud has a substantially circular shape with a center and a perimeter, and the female plugs are disposed proximal to the center, and wherein the one branch which terminates in the male plug is longer than the other branches.

### BACKGROUND OF THE INVENTION

1. Field of the Invention

The present invention relates generally to the field of protective extension cords and more particularly to a portable multibranch protective extension cord for multi-unit electronic systems. More specifically the present invention relates to a multibranch protective extension cord for supplying electric power to a multi-unit electrical system, which includes a female plug having a shroud, several surge protection components contained in the shroud, several branches branching away from the female plug, each branch terminating at its distal end in a plug, and one of the plugs is configured, such as in the form of a male plug for connection to a main power source.

2. Description of the Prior Art

There have long been electronic systems configured as multiunit systems, such as in the form of small computer assemblies that include a computer unit, an external disk unit, a monitor unit and other peripheral computer units. Usually such systems require their own means of connection to the common main power source. Such systems also usually include a common protector unit having built-in protective components for protecting the electronic units against damaging main power voltage surges, for example, caused by lightning or crosses with high voltage power lines.

As a result small computer systems and other electronic systems, such as home entertainment systems, usually end up having on their rearward sides an unsightly, space-consuming tangle of power cords.

Another typical multi-unit system is an electric office typewriter which has on its rearward back side a main power jack for connection to a main alternating current (ac) power source. Often there is a need to power other electrical units used by the typist, but there may not be an adequate number of available power outlets to power such other units.

Inventors have in the past sought to overcome this problem. Michelin, U.S. Pat. No. 3,535,638, issued on Oct. 20, 1970, discloses an electrical unit for use in testing or repairing television receiver sets including means for detachable fastening to the set. Michelin includes a plug adapter having a standard jack extension on one side and, on the other side, a polarized jack extension for connection to a television chassis power plug, and a power supply cable extending from the bottom of the adapter and having a conventional plug 19 at its end and a flexible goose-neck lamp bracket rising from the top of the adapter and carrying a lamp for illuminating the work. Michelin does not teach surge suppression and does not teach multiple branches connecting a primary system unit to multiple secondary system units.

Examples of prior patents teaching surge suppression and related functions are Cooper et al., U.S. Pat. No. 4,630,163, issued on Dec. 16, 1986, teaches a method and apparatus for a transient-suppression network; Cornell, U.S. Pat. No. 1,845,865, issued on Mar. 1, 1932, discloses a voltage regulator for alternating current apparatus; Phillips, Jr., U.S. Pat. No. 4,075,676, issued on Feb. 21, 1978, teaches interrupter; Crosby, et al., U.S. Pat. No. 4,628,394, issued on Dec. 9, 1986, reveals a voltage surge suppressor; Leopold, U.S. Pat. No. 4,688,135, issued on Aug. 18, 1987, discloses a duplex electrical receptacle with replaceable surge suppressor; Speet, et al., U.S. Pat. No. 4,703,386, issued on Oct. 27, 1987, reveals a power receptacle and associate filter with a branching circuit with filter components; Stifter, U.S. Pat. No. 4,259,705, issued on Mar. 31, 1981, showing a branching circuit with a surge suppressor and filter and Leibensperger, et al., U.S. Pat. No. 4,500,150, issued on Feb. 19, 1985, reveals a device for electrifying a dining table.

None of the known art, however, overcomes the problems presented by unsightly tangled clusters of cords normally found behind multi-unit electrical systems.

It is thus an object of the present invention to provide a multibranch protective extension cord which is unified to define a single apparatus and which connects a primary system unit having electrical plug connection means to each of several secondary system units also having electrical plug connection means and to a power source and which protects the primary and secondary system units from power surges.

It is another object of the present invention to provide such a multibranch protective extension cord which is compact, highly portable and not subject to cord tangling.

It is still another object of the present invention to provide such a multibranch protective extension cord which is simple in appearance and aesthetically pleasing.

It is finally an object of the present invention to provide such a multibranch protective extension cord which is durable and relatively inexpensive to manufacture.

### SUMMARY OF THE INVENTION

The present invention accomplishes the above-stated objectives, as well as others, as may be determined by a fair reading and interpretation of the entire specification.

A multibranch protective extension cord electrical system is provided for supplying electric power to a multi-unit, which includes a female plug having a shroud, several surge protection components contained in the shroud, several branches branching away from the female plug in which each branch is terminated at its distal end in a plug, and one of the plugs is configured, such as in the form of a mail plug for connection to a main power source.

According to a further feature, there is provided a multibranch extension cord as above, in which each of the branches is a flexible conductor covered with elastically insulating material.

According to a still further feature, there is provided a multibranch extension cord as above, in which at least the male plug is a three-terminal plug.

According to still another feature a multibranch extension cord, as described above, is provided in which at least one terminal of the three terminal plug is ground-connected.

According to still another feature, a multibranch extension cord as described above is provided in which the surge protection components include at least one voltage breakdown component, in which at least one of the surge protection components is an impedance component, and in which at least one of the voltage breakdown components has one pole connected to one of the ground-connected terminals, and another pole connected to one of the other terminals.

Finally, a multibranch protection cord as described above is provided in which the shroud is of substantially circular shape has a perimeter and a center, and in which each of the female plugs is disposed proximal to the perimeter and the male plug is disposed proximal to the center, and in which the one branch which terminates in the male plug is longer than the other branches.

Further objects and advantages of this invention will be apparent from the following detailed description of a presently preferred embodiment which is illustrated schematically in the accompanying drawings.

### BRIEF DESCRIPTION OF THE DRAWINGS

Various other objects, advantages, and features of the invention will become apparent to those skilled in the art from the following discussion taken in conjunction with the following drawings, in which:

FIG. 1 is a perspective view of the invention showing its basic parts;

FIGS. 2 and 3 are views as in FIG. 1 showing alternative versions of the invention in which the branches extend laterally from the main female plug, to make the present cord apparatus flat and able to fit into a narrower space between the unit and wall.

FIG. 4 is an elevational view showing typically the rearward side of a major component of an electronic system, such as a computer or the like;

FIG. 5 is an elevational view of the invention showing the branches enclosed in a molded shroud;

FIG. 6 is a plan view of the invention showing the male power plug surrounded by female plugs; and

FIG. 7 is a circuit diagram of the invention showing its major parts.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various FIGURES are designated by the same reference numerals.

### First Preferred Embodiment

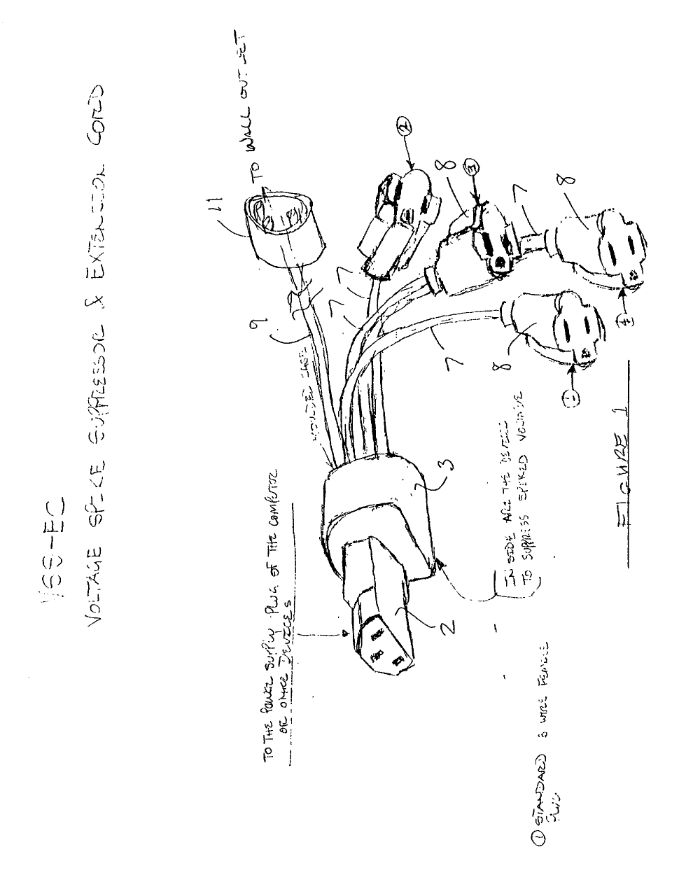

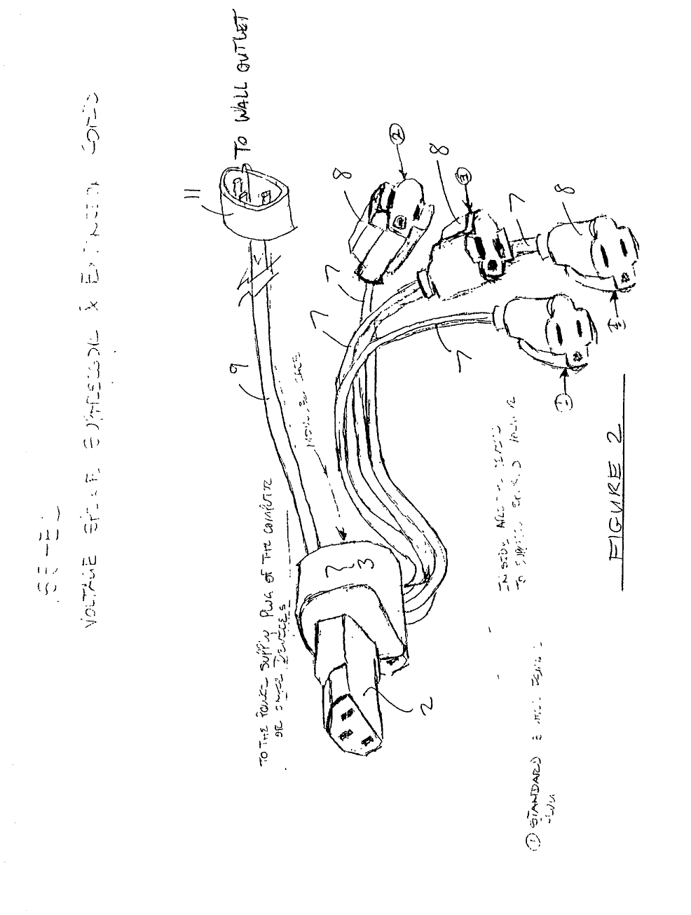

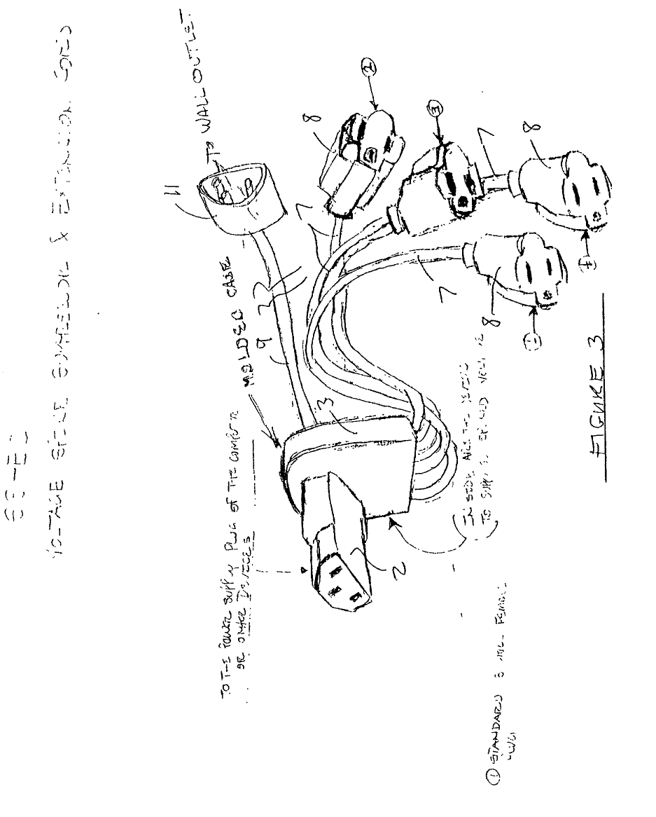

Referring to FIGS. 1-7, a multibranch extension cord system 10 is disclosed which includes a main female plug 2 having three terminals enclosed in a molded shroud 3. See FIG. 1. The shrouded female plug is advantageously structured to be receivable in plus connection means such as a matching male plug, such as plug 4 as shown in FIG. 4, mounted on the rearward side of a primary system unit such as an electrical unit 6, which may be a computer, a radio tuner or any other type of electrical or electronic unit in an electrical or electronic system or assembly.

Facing away from the shrouded female plug 2 there are a multiplicity of branches 7, each advantageously formed as a flexible electrical conductor. Each branch 7, except one, is terminated at its distal end, away from the shrouded female plug 2, in a distal female plug 8 for connection to a plug connection means in the form of a matching female plug mounted on the rearward side of a secondary system unit such as a computer printer. Each distal female plug 8 is enclosed in a molded shroud, having two or three openings for access to internal power conductors in the plug. The three openings are typically phase (P), which is the “hot” high voltage conductor, neutral (N) which is the current return conductor, and protective ground (G), connected to protective building ground or the like. Sometimes, only two conductors, phase and neutral, are provided. One branch 9 is different from branches 7 in that it is terminated in a plug 11 configured for connection of the entire extension cord to a main power source, plug 11 preferably being configured as a male plug. The branch 9 is either shorter than branches 7 and is connected to a wall-mounted power outlet by means of an interconnecting linking cord of conventional and common construction, or is substantially longer than branches 7, which only have to reach individual units within the system, to reach a wall-mounted power outlet by itself or with an extension cord.

Each of the branches 7 and 9 is covered with a flexible insulating cover of rubber, neoprene or the like. In one preferred embodiment of the invention the shroud 3 for the main female plug 2 is enlarged so that it is capable of containing protective components which serve to protect all the electronic units connected to the extension cord against damage caused by electronic power surges, such as lightning or power line crosses entering the cord from the main power source.

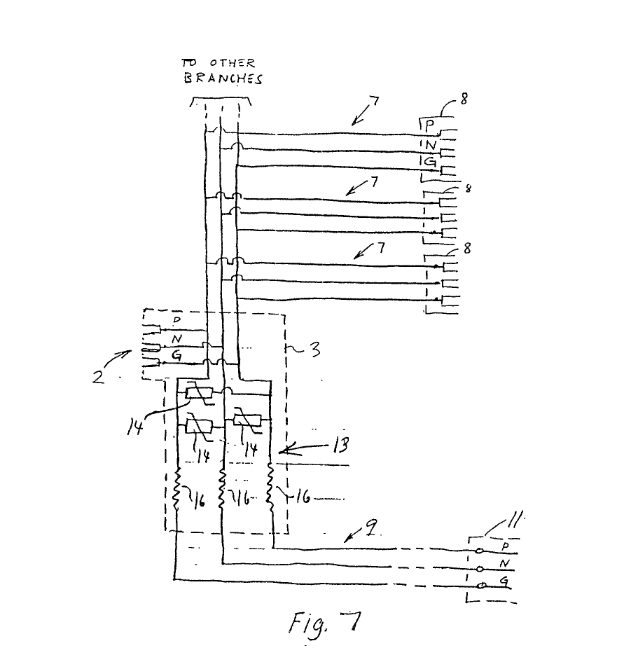

The protective components can be of many different types, substantially dividable into two groups: namely voltage breakdown components which revert to a low impedance stage when exposed to high voltage surges, and impedance types which limit the surge current to an acceptable magnitude. The invention is not directed to the particular construction of the surge protectors or the protective circuit but one typical arrangement is shown in FIG. 7 as described in more detail below.

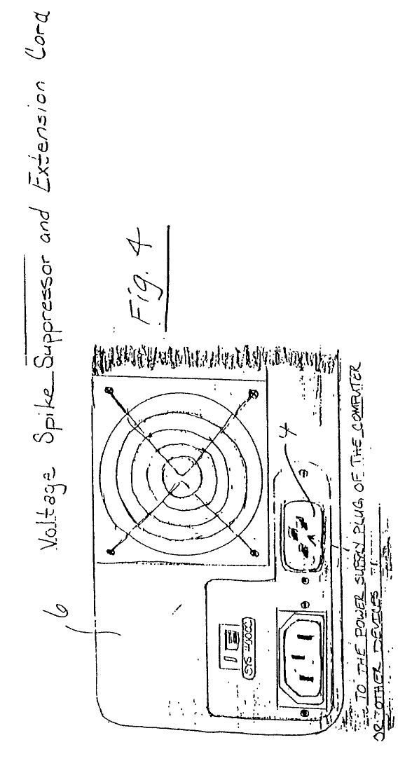

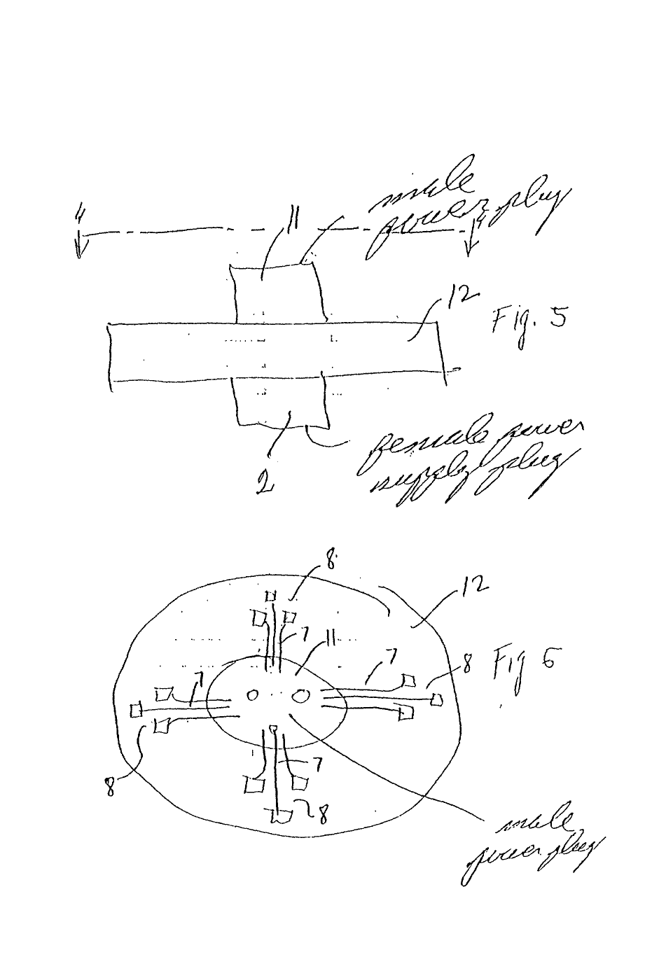

In the embodiment shown in FIGS. 5 and 6, the protective extension cord is completely enclosed in the shroud which is shaped as a disk-like body 12 having the male plug 11 extending perpendicularly to one side and the female plug 2 extending perpendicularly to the opposite side.

The branches 7 are in this embodiment completely enclosed in the shroud 12, with the female plugs 8 arranged peripherally around the center area of the disk-shaped body.

In operation, the disk-shaped body 12 is attached with its male plug 11 in engagement with a main female power supply plug on the rearward side of one of the electronic components, e.g., the computer 6 in FIG. 4, and the other system components are plugged with short single extension cords into the peripherally arranged female plugs 8.

FIG. 7 is a circuit diagram of the extension cord according to the invention, showing the female power plug 2 with the three terminals P, N and G, connected via the branches 7 to the female plugs 8 and via a protective circuit 13 enclosed in shroud 3, with the male plug 11 connected to branch 9.

The protective circuit 13 is shown in typical configuration, consisting of voltage breakdown components 14, each connected between respective two of the three conductors P, N & G, and three current-limiting components 16, each connected in series with a respective conductor P, N & G of the branch 9 connected to the male plug 11. The voltage breakdown components 14 are typically gas-discharge tubes, varistors or zener diodes, and the current limiting components 16 are typically resistors or inductors.

A current surge entering at the power plug 11 on one or several conductors P, N, G will first be limited to a relatively small current value of typically less than 100 amperes by the current limiting components 16, and the resulting voltage surge will be shorted by the voltage breakdown components 14 to a low value such as about 50 volts or less, which will cause no harm to systems components connected to plugs 2 and 8.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

I claim as my invention:

1. An electrical apparatus, comprising:
a multi-unit electrical system comprising a primary system unit having electrical plug connection means and a plurality of separate secondary system units each having electrical plug connection means;
multibranch protective extension cord for supplying electric power to said electrical plug connection means of said primary system unit and said electrical plug connection means of a plurality of said secondary system units, said multibranch protective extension cord comprising a female plug having a shroud; surge protection components contained in said shroud; a plurality of branches branching away from said female plug; each said branch having conductors and a branch distal end, said conductors being terminated at said distal end in a plug, one of said plugs being configured for connection to a main power source.

2. A multibranch extension cord according to claim 1, wherein each of said branches has a flexible cover of elastically insulating material.

3. A multibranch extension cord according to claim 1, wherein said plug being configured for connection to a main power source is configured as a male plug.

4. A multibranch extension cord according to claim 3, wherein at least said male plug is a three-terminal plug.

5. A multibranch extension cord according to claim 4, wherein at least one terminal of said three terminal plug is ground-connected.

6. A multibranch extension cord according to claim 1, wherein said surge protection components include at least one voltage breakdown component.

7. A multibranch extension cord according to claim 1, wherein at least one of said surge protection components is a current-limiting component.

8. A multibranch extension cord according to claim 5, including a plurality of voltage breakdown components, each connected between respective two of said conductors.

9. A multibranch protective cord according to claim 1, wherein said shroud has a substantially disk-shaped body, having a perimeter and a center, and each female plug is disposed proximal to said perimeter, and said male plug is disposed proximal to said center.

10. A multibranch protective cord according to claim 9, wherein said disk-shaped body has a body first side and a body second side, and wherein said male plug extends perpendicularly to said body first side, and including a centrally disposed female plug extending perpendicularly to said body second side.

11. A multibranch protective cord according to claim 1, wherein one branch terminated in said male plug is longer than the other said branches.

12. An electrical apparatus for supplying electric power to a multi-unit electrical system comprising a primary system unit having electrical plug connection means and a plurality of separate secondary system units each having electrical plug connection means, comprising:
multibranch protective extension cord for supplying electric power to said electrical plug connection means of said primary system unit and said electrical plug connection means of a plurality of said secondary system units, said multibranch protective extension cord comprising a female plug having a shroud;
surge protection components contained in said shroud;
a plurality of branches branching away from said female plug;
wherein each said branch has conductors and a branch distal end, said conductors being terminated at said distal end in a plug, one of said plugs being configured for connection to a main power source.
